(19) United States
(12) Patent Application Publication
(10) Pub. No.: US 2024/0325948 A1
(43) Pub. Date: Oct. 3, 2024

(54) FUEL-WATER SEPARATOR CONTAINMENT SYSTEMS AND METHODS FOR WATERCRAFT

(71) Applicant: Polaris Industries Inc., Medina, MN (US)

(72) Inventors: Craig Blume, Edwardsburg, MI (US); Blair Donat, Osceola, MN (US)

(21) Appl. No.: 18/584,025

(22) Filed: Feb. 22, 2024

Related U.S. Application Data
(60) Provisional application No. 63/456,181, filed on Mar. 31, 2023.

(51) Int. Cl. B01D 35/30; B01D 17/02; B63B 17/00; C02F 1/00

(52) U.S. Cl. CPC B01D 35/30; B01D 17/02; B63B 17/0027; C02F 1/001; C02F 2201/001

(57) ABSTRACT

A containment system for a fuel-water separator assembly on a watercraft. The containment system may be used to shield the fuel-water separator assembly from sunlight, enabling the containment system to be located outside existing above-deck compartments. When location within an existing compartment is desired, the containment systems, by virtue of isolating the fuel-water separator from the internal surroundings of the compartment, can be placed in closer proximity to electrical equipment, providing a greater degree of freedom with respect to the placement of the fuel-water separator assembly. The disclosed containment systems can be readily accessed for maintenance of the fuel-water separator. In some embodiments, the disclosed containment system is provided as a kit for retrofitting of existing watercraft.

### CROSS REFERENCE TO RELATED APPLICATIONS

This application claims the benefit of U.S. Provisional Application No. 63/456,181, filed on Mar. 31, 2023, entitled FUEL-WATER SEPARATOR CONTAINMENT SYSTEMS AND METHODS FOR WATERCRAFT, the entire contents of which is expressly incorporated by reference herein.

### BACKGROUND

Recreational watercraft have become increasingly sophisticated. Modern watercraft may include many electrical components, such as remote actuators, powered appliances, and entertainment systems. Also, state of the art power systems for the fuel train feature several interactive components for enhanced power and reliability.

A common component in watercraft power systems is the fuel-water separator. The fuel-water separators require routine maintenance, for example to change out the filter element. Watercraft codes, such as promulgated by the American Boat and Yacht Council (ABYC), forbid the water-fuel separator to operate in direct sunlight. Accordingly, it is common to mount the fuel-water separator in an above-deck compartment, such as a bench or console, that shields the device from sunlight while permitting ready access for maintenance. However, due to finite availability, such above-deck compartment space may also house electrical equipment, which ABYC codes require be offset at specified distances from the fuel-water separator. With electrical equipment becoming increasingly ubiquitous in modern watercraft, maintaining the required offsets between electrical components and fuel-water separators within the available limited compartment space is becoming increasingly challenging. A solution that alleviates the code proximity issues of fuel-water separators to electrical equipment would be welcomed.

### SUMMARY OF THE DISCLOSURE

This disclosure is directed generally to watercraft power systems and more specifically to fuel-water separator systems for marine motors. Various embodiments of the disclosure provide a containment system that houses a fuel-water separator assembly. The containment system itself shields the fuel-water separator assembly from sunlight, enabling the containment system to be located outside existing above-deck compartments. When location within an existing compartment is desired, the containment systems, by virtue of isolating the fuel-water separator from the internal surroundings of the compartment, can be placed in closer proximity to electrical equipment, providing a greater degree of freedom with respect to the placement of the fuel-water separator assembly. The disclosed containment systems can be readily accessed for maintenance of the fuel-water separator, and again as readily closed for continued operation. In some embodiments, the disclosed containment system is provided as a kit for retrofitting of existing watercraft.

### BRIEF DESCRIPTION OF THE DRAWINGS

FIG. 1 is a perspective view of a containment system for a fuel-water separator assembly according to an embodiment of the disclosure.

FIG. 2 is the containment system of FIG. 1 with a housing depicted in phantom for viewing internal components according to an embodiment of the disclosure.

FIG. 3 is an exploded view of the containment system of FIG. 1 according to an embodiment of the disclosure.

FIG. 4 is an elevational view of a fuel-water separator assembly to be housed in containment systems in embodiments of the disclosure.

FIG. 5 is a perspective view of an upper face of a centering frame for the containment system of FIG. 1 according to an embodiment of the disclosure.

FIG. 6 is a perspective view of a lower face of the centering frame of FIG. 5 according to an embodiment of the disclosure.

FIG. 7 is an enlarged, partial sectional view at inset plane VII of FIG. 2 according to an embodiment of the disclosure.

FIG. 8 is an upper perspective view of a housing for the containment system of FIG. 1 according to an embodiment of the disclosure.

FIG. 9 is a lower perspective view of the housing of FIG. 8 according to an embodiment of the disclosure.

FIG. 10 is a plan view of tension rods and a sectional view of a fixture of various containment systems according to embodiments of the disclosure.

FIG. 11 is a partial cutaway view of the containment system of FIG. 1 located in an above-deck compartment according to an embodiment of the disclosure.

FIG. 12 is an enlargement of the partial cutaway view of FIG. 11 at inset XII according to an embodiment of the disclosure.

FIGS. 13 through 16 are perspective views of an installation of the containment system of FIG. 1 according to an embodiment of the disclosure.

FIG. 17 is a plan view of a template for assistance of the installation of FIGS. 13 through 16 according to an embodiment of the disclosure.

FIG. 18 is a perspective view of a containment system including an alternative fuel-water separator according to a second embodiment of the disclosure.

FIG. 19 is a plan view of a template for assistance in the installation of the containment system of FIG. 18 according to an embodiment of the disclosure.

FIG. 20 is a perspective view of a containment system according to a third embodiment of the disclosure.

FIG. 21 is an enlarged, partial sectional view at inset plane XXI of FIG. 20 with a tension rod depicted in phantom according to an embodiment of the disclosure.

### DETAILED DESCRIPTION OF THE FIGURES

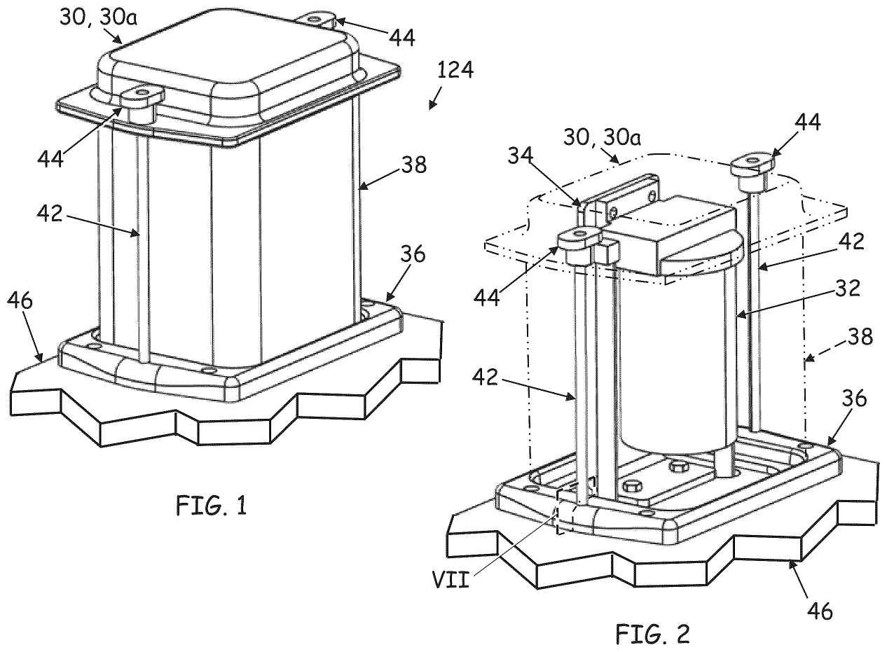

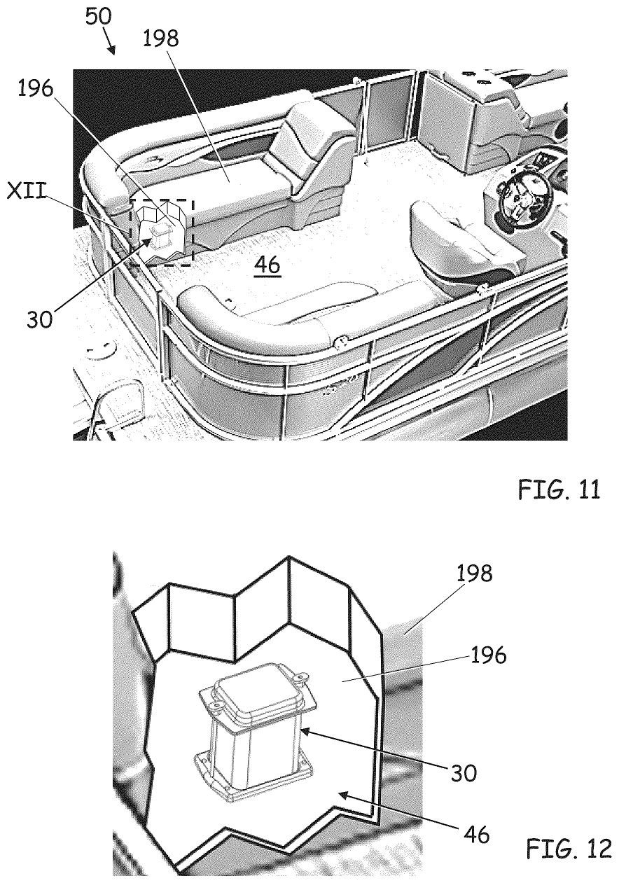

Referring to FIGS. 1 through 4, a containment system 30 for a fuel-water separator assembly 32 is depicted according to an embodiment of the disclosure. The containment system 30 includes the fuel-water separator assembly 32 mounted to a bracket 34 surrounded by a centering frame 36 and covered by a housing 38. The containment system 30 may include one or more tension rods 42 and fixtures 44 that secure the housing 38 to the centering frame 36. The containment system 30 may be mounted to a deck or platform 46 of a watercraft 50 (FIG. 11), through which a fuel line 48 is routed for connection to the fuel-water separator assembly 32.

The watercraft 50 may be, for example, a pontoon boat (depicted).

The fuel-water separator assembly 32 is available commercially and typically tailored to the specifications of a specific marine engine. The fuel-water separator assembly 32 includes connections 62 for in-line coupling to the fuel line 48, for example hose barb connections 64. A filter portion 66 may be connected in sealed engagement to a filter head 68 from which the filter portion 66 depends. Alternatively, the filter portion 66 is connected to a filter base (not depicted) which supports the filter portion 66.

In some embodiments, the bracket 34 includes a base portion 72 and an upright portion 74. The base portion 72 defines at least one through-hole 76 that receives a fastener or fasteners 78 for affixing the bracket to the platform 46. The fastener(s) 78 may be, for example, a lag bolt (depicted) or a wood screw suitable for threading into a wood material or composite platform 46. The upright portion 74 extends vertically from the base portion 72 and defines a plurality of mounting apertures 82 configured to receive corresponding mounting fasteners 84 for mounting the fuel-water separator assembly 32. In some embodiments, the plurality of mounting apertures 82 replicate a pattern specified by the marine motor manufacturer for the specific filter head 68 of the fuel-water separator assembly 32. The fasteners 78, 84 may include any of a variety of head forms to accommodate various drivers, for example, hex head (depicted), screw driver, or a socket head driver such as a hex bit, a square bit, or a TORX® bit.

The disclosure presents several embodiments of the containment system 30, which are referred to generically or collectively by reference character 30 and specifically or individually with a letter suffix. Accordingly, the containment system 30 presented in FIGS. 1 through 3 are referred to as containment system 30a. Various components specific to a given embodiment may also be referred to with the same letter suffix (e.g., the tension rod 42 for containment system 30a may be referred to as “tension rod 42a”). The letter suffix identifier convention is applied herein to, for example, centering frames 36, housings 38, and tension rods 42 and the various components and attributes thereof.

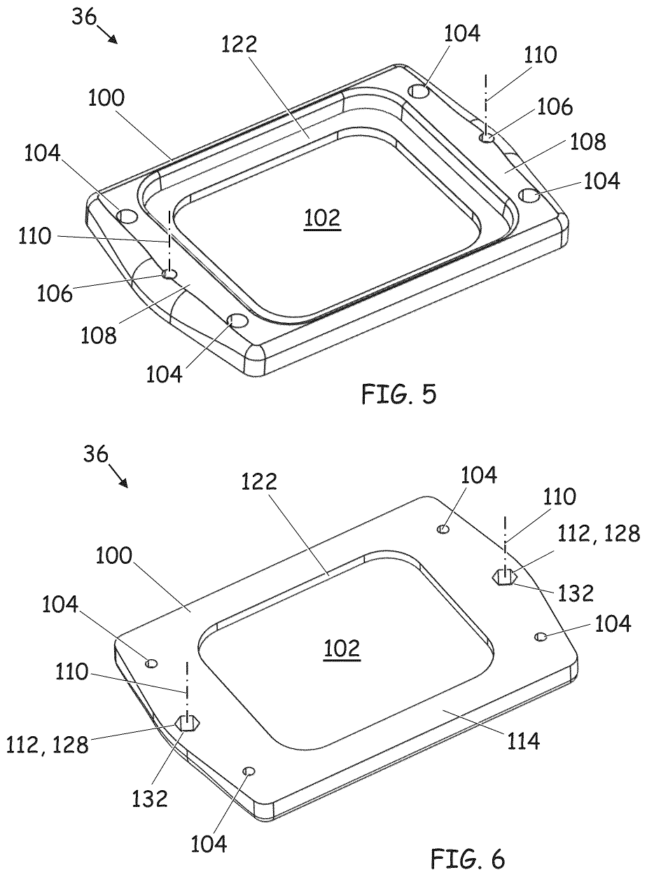

Referring to FIGS. 5 through 7, a centering frame 36a is depicted in more detail according to an embodiment of the disclosure. The centering frame 36, 36a includes at least one frame member 100 that defines an opening 102 for surrounding the base portion 72 of the bracket 34 (FIG. 2). In some embodiments, the centering frame 36, 36a defines a plurality of mounting apertures 104 that receives corresponding fasteners (not depicted) for affixing the centering frame 36 to the platform 46 of the watercraft 50. The centering frame 36, 36a may define a plurality of through-apertures 106, 106a that extend through an upper face 108 of the centering frame 36, 36a. In some embodiments, the centering frame 36, 36a defines at least one cavity 112, 112a accessible from a lower face 114 of the centering frame 36, 36a, each of the plurality of through-apertures 106, 106a defining and being colinear with an aperture axis 110 that extends into a corresponding of the at least one cavity 112, 112a. Each of the at least one cavity 112, 112a defines an inner dimension 116 that is greater than a diameter 118 of the through-apertures 106, 106a.

In some embodiments, the centering frame 36, 36a includes an internal flange or lip 122 that extends radially inward (FIG. 7). The housing 38 may coupled to the centering frame 36, 36a in axial alignment with the internal lip 122 when in a closed configuration 124 (FIGS. 1 and 16, i.e., when the housing 38 is seated within the centering frame 36). In some embodiments, the housing 38 is seated on a gasket 126 disposed interstitially between the housing 38 and the internal lip 122 (depicted). Alternatively, the housing 38 is seated directly against the internal lip 122. In some embodiments, the housing 38 is not axially aligned with the internal lip 122 (or there is no internal lip) so that the housing 38 is seated within the opening 102 defined by the centering frame 36, 36a.

In some embodiments, the at least one cavity 112, 112a is a plurality of cavities 128, 128a (depicted), each of the plurality of cavities 128, 128a defining a cross-section 132 that is normal to the respective aperture axis 110 and dimensioned to receive and rotationally capture a head portion 134, 134a of the tension rod 42 residing therein. In some embodiments, each of the at least one frame member 100 of the centering frame 36, 36a defines a hollow (not depicted) accessible from the lower face 114 of the centering frame 36, 36a, the hollow defining the at least one cavity 112, 112a. The depicted centering frame 36, 36a is substantially rectangular in shape. Other shapes are also contemplated, including but not limited to circular, oval, or polygonal.

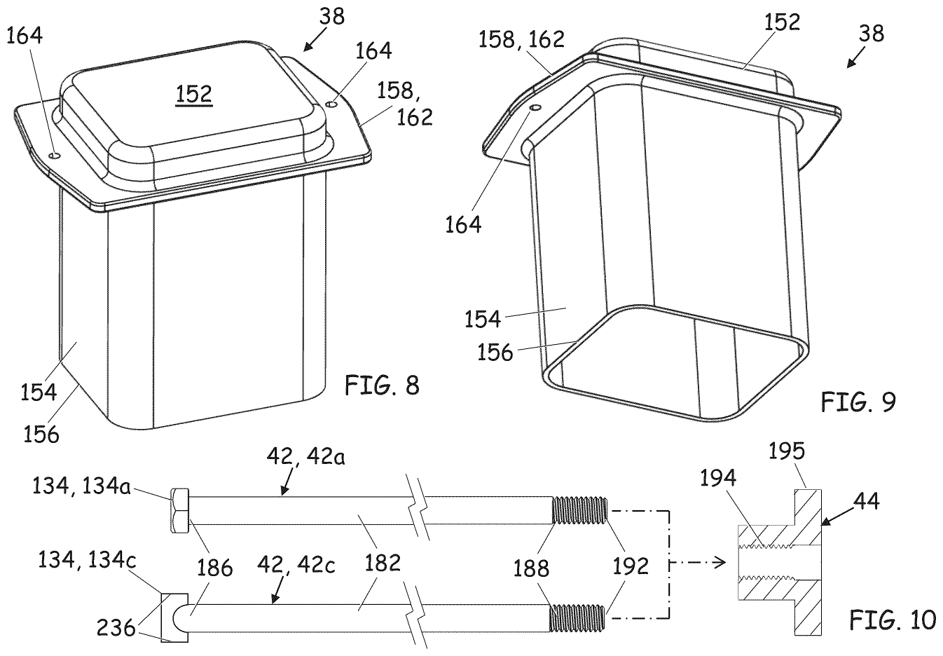

Referring to FIGS. 8 and 9, a housing 38a is described in greater detail according to an embodiment of the disclosure. The housing 38, 38a includes a closed top portion 152 and an open bottom portion 154, the open bottom portion 154 defining a radial outer perimeter 156 shaped and dimensioned to seat within the centering frame 36, 36a. The housing 38, 38a may include one or more radial projections 158, such as a flange portion 162 with radial dimensions that are greater than the radial outer perimeter 156. In some embodiments, the radial projection(s) 158 define a plurality of through-slots 164, 164a, each for axial alignment with a corresponding one of the plurality of through-apertures 106 of the centering frame 36. In some embodiments, the through-slots 164, 164a are circular.

Referring to FIG. 10, tension rods 42 and the fixtures 44 are described in greater detail according to an embodiment of the disclosure. The plurality of tension rods 42 correspond to the plurality of through-apertures 106 of the centering frame 36 and to the plurality of through-slots 164 of the one or more radial projections 158 of the housing 38. Each of the plurality of tension rods 42 include a shaft portion 182 and the head portion 134, the head portion 134 being disposed at a first end 186 of the shaft portion 182. The shaft portion 182 defines a threaded portion 188 that extends to a second end 192 of the shaft portion 182. Each tension rod 42 is extendible through a respective one of the plurality of through-apertures 106 of the centering frame 36 for capturing the head portion 134 within the at least one cavity 112 of the member(s) 100 of the centering frame 36. Each tension rod 42 is also extendible through a respective one of the plurality of through-slots 164 of the radial projection(s) 158 for extending the threaded portion 188 through the radial projection(s) 158.

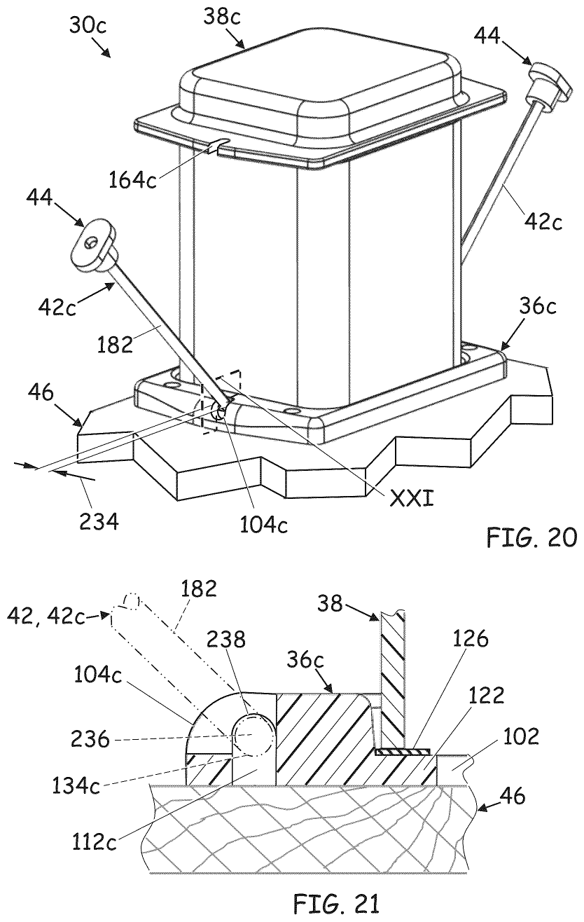

Two embodiments for the tension rods 42—42a and 42c—are depicted at FIG. 10. The tension rod 42a is utilized in containment system 30a, whereas tension rod 42c is utilized in containment system 30c. The tension rods 42a and 42c, as depicted, differ only in the head portions 134a and 134c. Head portion 134a is a depicted as a conventional hex head. Head portion 134c is a cross-cylinder, described in greater detail attendant to FIGS. 20 and 21.

The fixtures 44, one for each of said plurality of tension rods 42, are configured to receive the threaded portion 188 of the tension rod 42. In the depicted embodiment, the fixtures 44 define a female thread 194 to secure the tension rods 42 to the radial projection(s) 158. The fixtures 44 may also include knob portions 195 for manual gripping.

Referring to FIGS. 11 and 12, placement of the containment system 30 for the fuel-water separator assembly 32 on the platform 46 of the watercraft 50 is depicted according to an embodiment of the disclosure. In some embodiments, the containment system 30 is placed within a compartment 196 of the watercraft 50, for example a seating bench (depicted). The compartment 196 may be accessible by removal of a closure 198, for example a seat cushion assembly (depicted). Alternatively, the containment system 30 may be positioned on the platform 46 outside of any compartment of the watercraft 50.

Functionally, disposing the fuel-water separator assembly 32 within the containment system 30 enables a greater degree of freedom with respect to the placement of the fuel-water separator assembly 32. For example, the containment system 30 can be placed within the compartment 196 in close proximity to neighboring electrical components without violating existing watercraft codes. The protection provided by the housing 38 also enables the containment system 30 to be placed on the platform 46 in a location subject to direct sunlight, again without violation of watercraft codes. The housing 38 can be readily removed for servicing the fuel-water separator assembly 32, for example to replace filter portion 66. The bracket 34 enables location of the fuel-water separator assembly 32 away from walls and barriers to which such separators are typically mounted, thereby enabling the housing 38 to surround the fuel-water separator assembly 32.

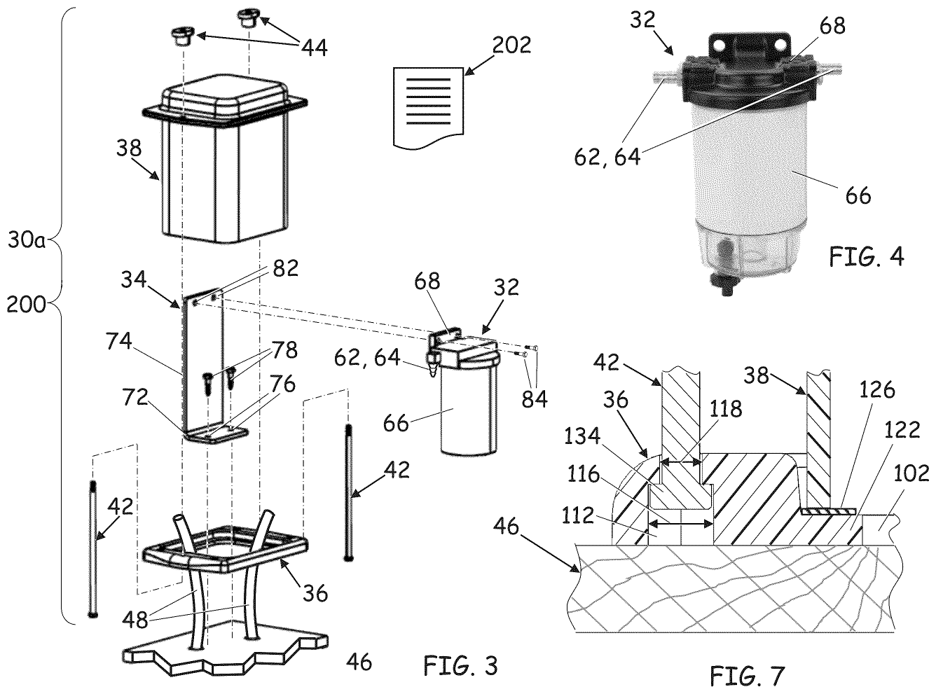

In some embodiments, some or all of the components of the disclosed systems are provided as a kit 200 (depicted at FIG. 3), complete with instructions 202 for installation and/or use. The instructions 202 are provided on a tangible, non-transitory medium, and may be physically included with the kit 200 such as on a printed document (depicted), compact disc, or flash drive. Non-limiting examples of a tangible, non-transitory medium include a paper document and computer-readable media including compact disc and magnetic storage devices (e.g., hard disk, flash drive, cartridge, floppy drive). The computer-readable media may be local or accessible over the internet. The instructions 202 may be complete on a single medium or divided among two or more media. For example, some of the instructions 202 may be written on a paper document that instruct the user to access one or more of the steps of the method over the internet, the internet-accessible steps being stored on a computer-readable medium or media. The instructions 202 may embody the techniques and methods depicted or described herein using text, photos, videos, or a combination thereof to instruct and guide the user. The instructions may be in the form of written words, figures, photos, video presentations, or a combination thereof to instruct and guide the user.

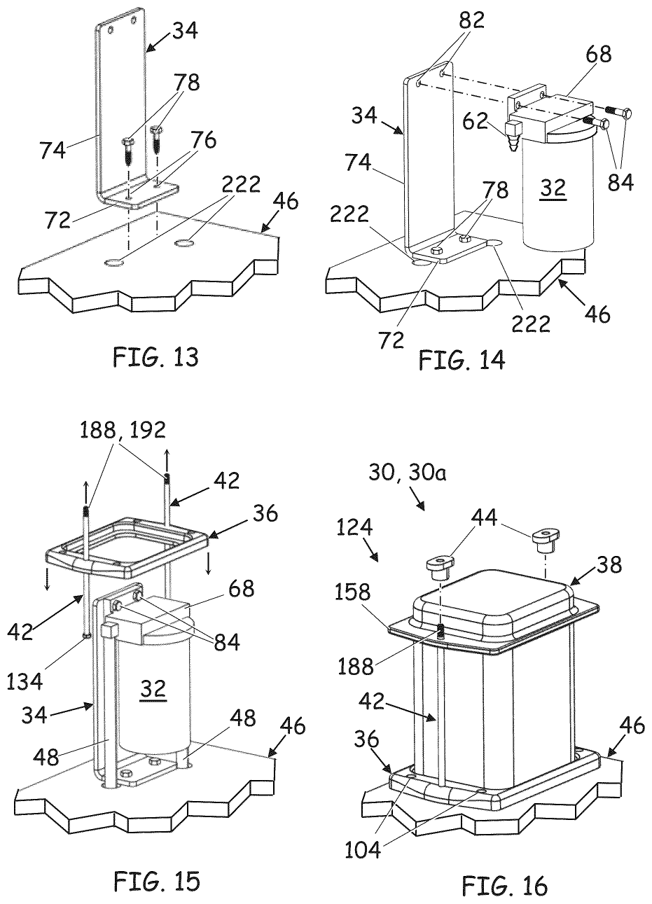

Referring to FIGS. 13 through 16, a method of installation the containment system 30, 30a is depicted according to an embodiment of the disclosure. The method may include boring access holes 222 in the platform 46 for passage of the fuel line 48 to and from the fuel-water separator assembly 32 (FIG. 13). The bracket 34 is positioned in a location relative to the access holes 222 and secured to the platform 46 with the fastener(s) 78 through the through-hole(s) 76 (FIGS. 13 and 14). The filter head 68 (or, alternatively, a filter base) of the fuel-water separator assembly 32 is aligned with the mounting apertures 82 of the bracket 34 and the fuel-water separator assembly 32 affixed to the bracket 34 with the mounting fasteners 84 (FIGS. 14 and 15). The fuel line 48 is connected to the connections 64 of the fuel-water separator assembly 32 (FIG. 15). The tension rods 42 are inserted through the through-apertures 106 of the centering frame 36 so that the head portions 134 can access the cavity or cavities 112 from the lower face 114 of the centering frame 36 (FIG. 15). The centering frame 36 may be positioned on the platform 46 for centering the housing 38 in a position that does not physically contact the fuel-water separator assembly 32 when seated in the centering frame 36 and is secured to the platform 46 (FIG. 16), for example with fastening screws (not depicted) that are coupled with the platform 46 through the mounting apertures 104. The housing 38 is aligned and seated within the centering frame 36 and the threaded portions 188 of the tension rods 42 passed through the through-slots 164 of the radial projection(s) 158 (FIG. 16). The housing 38 is secured to the centering frame 36 with the fixtures 44 (FIG. 16) by threading the fixtures 44 onto the threaded portions 188 of the tension rods 42 and tightening the fixtures 44 against the radial projection(s) 158.

The depictions of FIGS. 13 through 16 present the containment system 30a, but the steps of the method as described apply generally to all containment systems 30 disclosed herein. Any modifications to the steps described that may be required as between different embodiments of the disclosed containment systems 30 are understood by persons of skill in the relevant arts in view of this disclosure.

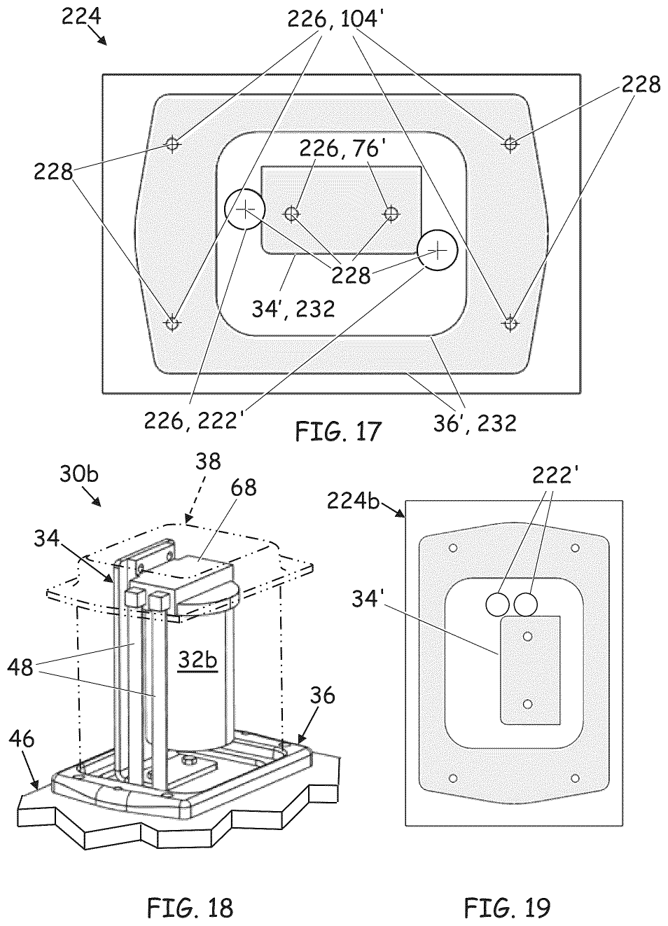

Referring to FIG. 17, a template 224 for laying out various components of the containment system 30 is depicted according to an embodiment of the disclosure. The template 224 may be included with the instructions 202 (FIG. 3) to assist the user in the method of installation. The template 224 may include hole patterns 226 and/or hole center locations 228 for the installation. In the depicted embodiment, the hole patterns 226 and/or center locations 228 include pattern 222′ corresponding to the locations and sizes of the access holes 222, pattern 76′ for locating the through-hole(s) 76 of the base portion 72, and pattern 104′ for locating the through-apertures 104 of the centering frame 36. In some embodiments, the template 224 includes outlines 34′ and 36′ for the base portion 72 of the bracket 34 and the frame member(s) 100 of the centering frame 36, respectively.

In operation, the template 224 is positioned where the containment system 30 is to be located and may be mounted to the platform 46, for example with tape, pins, or staples. In some embodiments, the template may include an adhesive layer for adhering, at least temporarily, to the platform 46. In some embodiments, the template 224 is provided on a printable medium, for example paper or tag board, and a tool (e.g., punch or nail) used to pierce the template at the hole center locations 228 to form starter divots on the platform 46 for marking the hole patterns 226.

The template 224 may then be removed to commence with boring the access holes 222 and affixing the bracket 34 and centering frame 36. Alternatively, the template 224 may be left in place for the mounting of the bracket 34 and centering frame 36, enabling the user to utilize the outlines 34′ and 36′ to locate the bracket 34 and centering frame 36. In some embodiments, the template may be of a stout material, such as a metal or polymer. As such, the template 224 may be used to trace the hole patterns 226 on the platform 46. In some embodiments, the template 224 may define through-slots 232 that partially follow the outlines 34′ and 36′ to enable a partial tracing of the outlines 34′ and 36′ on the platform 46 for positioning of the bracket 34 and centering plate 36. In some embodiments, the stoutness of the template 224 may enable the template 224 to be used to guide the drill for boring the access holes 222 through the platform 46.

Referring to FIGS. 18 and 19, a containment system 30b is depicted in an embodiment of the disclosure. The containment system 30b may include many of the same components and attributes as the containment system 30a, some of which are indicated by same-labeled reference characters. A distinction of the containment system 30b is that it is configured to house a fuel-water separator assembly 32b that is of different construction than a fuel-water separator assembly 32a as depicted for the containment system 30a. Specifically, the fuel inlet and outlet are located on the same side of the filter head 68, an aspect common to many fuel-water separator assemblies 32. The location of the access holes 222 and the bracket 34 within the centering frame 36 may be arranged differently for improved clearance between the housing 38 and the fuel-water separator assembly 32b, as evinced by a template 224b depicted at FIG. 19 for installing the containment system 30b.

The containment systems 30a and 30b demonstrates the versatility of disclosed containment system 30 to accommodate numerous layouts of the various components within. In some embodiments, the patterns 76′, 104′, 222′ and outlines 34′, 36′ of the installation template 224, as well as the pattern of the mounting apertures 82 of the bracket 34, are matched to a certain fuel-water separator assembly 32. Accordingly, a variety of kits 200 may be configured and made available for various makes and models of marine motors.

Referring to FIGS. 20 and 21, a containment system 30c is depicted according to an embodiment of the disclosure. The containment system 30c may include many of the same components and attributes as the containment systems 30a, 30b, some of which are indicated by same-labeled reference characters. A distinction of the containment system 30c is a housing 38c that defines through-slots 164c that are open ended. Also, a centering frame 36c may define through-apertures 104c and cavities 112c. The through-apertures 104c may be slotted to define a minor dimension 234 that enables passage of the shaft portion 182 of the tension rods 42 while capturing the head portion 134 within the cavity 112c. In some embodiments, a cross-cylindrical head portion 134c extends from and normal to the first end 186 of the shaft portion 182 (FIG. 10), with opposed ends 236 of the cross-cylindrical head portion 134c extending under both sides of the slotted through-aperture 104c. The cavity 112c may define arcuate profiles 238 that extend on both sides of the through-aperture 104c, against which the opposed ends of the cross-cylindrical head portion 134c register when the tension rods 42 are in tension.

Functionally, the open ends of the through-slots 164c enable the tension rods 42c to access the through-slots 164c from the sides (i.e., in the radial direction). As such, the housing 38 can be seated in the centering frame 36 without need for axial alignment between the tension rods 42c and the through-slots 164c. The slotted through-apertures 104c, as well as the cross-cylindrical head portion 134c and arcuate profiles 238, facilitate lateral rotation of the tension rods 42c into the open ended through-slots 164c to secure the housing 38 within the centering frame 36, and also facilitate lateral rotation of the tension rods 42c out of the open ended through-slots 164c to release the housing 38 from the centering frame 36. In some embodiments, the fixtures 44 may remain coupled to the tension rods 42c during the lateral rotation, and merely tightened/loosened with respect to the radial projection(s) 158 to secure/release the housing 38.

Each of the additional figures and methods disclosed herein can be used separately, or in conjunction with other features and methods, to provide improved devices and methods for making and using the same. Therefore, combinations of features and methods disclosed herein may not be necessary to practice the disclosure in its broadest sense and are instead disclosed merely to particularly describe representative and preferred embodiments.

Various modifications to the embodiments may be apparent to one of skill in the art upon reading this disclosure. For example, persons of ordinary skill in the relevant arts will recognize that the various features described for the different embodiments can be suitably combined, un-combined, and re-combined with other features, alone, or in different combinations. Likewise, the various features described above should all be regarded as example embodiments, rather than limitations to the scope or spirit of the disclosure.

Persons of ordinary skill in the relevant arts will recognize, in view of this disclosure, that various embodiments can comprise fewer features than illustrated in any individual embodiment described above. The embodiments described herein are not meant to be an exhaustive presentation of the ways in which the various features may be combined. Accordingly, the embodiments are not mutually exclusive combinations of features; rather, the claims can comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no patent claims included in the documents are incorporated by reference herein. Any incorporation by reference of documents above is yet further limited such that any definitions provided in the documents are not incorporated by reference herein unless expressly included herein.

Unless indicated otherwise, references to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art.

For purposes of interpreting the claims, it is expressly intended that the provisions of 35 U.S.C. 112(f) are not to be invoked unless the specific terms “means for” or “step for” are recited in the respective claim.

The following clauses illustrate examples subject matter described herein.

Clause 1: A containment system for a fuel-water separator assembly, comprising: a bracket including a base portion and an upright portion, said base portion defining a through-hole that receives a fastener for affixing said bracket to a platform of a watercraft, said upright portion extending vertically from said base portion and defining a plurality of mounting apertures configured to receive corresponding mounting fasteners for mounting a fuel-water separator assembly, said plurality of mounting apertures defining a pattern that corresponds to a mounting hole pattern for said fuel-water separator assembly; a centering frame including at least one frame member for surrounding said base portion of said bracket, said centering frame defining a plurality of mounting apertures that receives corresponding fasteners for affixing said centering frame to said platform of said watercraft, said centering frame defining a plurality of through-apertures that extend through an upper face of said centering frame, said centering frame defining at least one cavity accessible from a lower face of said centering frame, each of said plurality of through-apertures extending into a corresponding of said at least one cavity, each of said at least one cavity defining an inner dimension that is greater than a diameter of the through-apertures of said plurality of through-apertures; a housing including a closed top portion and an open bottom portion, said open bottom portion defining a radial outer perimeter dimensioned to seat within said centering frame, said housing including one or more radial projections with radial dimensions that are greater than said radial outer perimeter, said one or more radial projections defining a plurality of through-holes, each of said plurality of through-holes for axial alignment with a corresponding one of said plurality of through-apertures of said centering frame; a plurality of tension rods corresponding to said plurality of through-apertures of said centering frame and to said plurality of through-holes of said one or more radial projections of said housing, each of said plurality of tension rods including a shaft portion and a head portion, said head portion being disposed at a first end of said shaft portion, said shaft portion defining a threaded portion that extends to a second end of said shaft portion, each tension rod being extendible through a respective one of said plurality of through-apertures of said centering frame for capturing said head portion within said at least one cavity of said centering frame and through a respective one of said plurality of through-holes of said one or more radial projections for extending said threaded portion through said at least one radial projection; and a plurality of fixtures, one for each of said plurality of tension rods, for receiving said threaded portion of one of said plurality of tension rods to secure said one of said plurality of tension rods to said at least one radial projection.

Clause 2: The containment system of claim 1, wherein said fastener is one of a wood screw and a lag bolt.

Clause 3: The containment system of claim 1 or 2, wherein said watercraft is a pontoon boat.

Clause 4: The containment system of any one of claims 1 through 3, wherein said mounting fastener is a bolt having one of a hex head, a screw driver, and a socket head.

Clause 5: The containment system of any one of claims 1 through 4, wherein said mounting aperture is threaded for threaded coupling with said mounting fastener.

Clause 6: The containment system of any one of claims 1 through 5, wherein said centering frame includes an internal lip that extends radially inward, said housing being coupled to said centering frame in axial alignment with said internal lip in a closed configuration.

Clause 7: The containment system of any one of claims 1 through 6, wherein said at least one cavity is a plurality of cavities, each of said plurality of cavities defining an axial cross-section dimensioned to receive and rotationally capture said head portion of said tension rod.

Clause 8: The containment system of any one of claims 1 through 7, wherein each of said at least one frame member of said centering frame defines a hollow accessible from said lower face of said centering frame, said hollow defining said at least one cavity.

Clause 9: The containment system of any one of claims 1 through 8, wherein each of said plurality of fixtures includes a knob for manual manipulation of the fixture onto the threaded portion of said tension rod.

Clause 10: A method for containment of a fuel-water separator assembly, comprising: providing a kit including the containment system of any one of claims 1 through 9; and providing instructions on a tangible, non-transient medium, said instructions including: placing said housing into said centering frame to cover said bracket and a fuel-water separator assembly mounted to said bracket; and securing said housing to said centering frame with said plurality of tension rods and said plurality of fixtures.

Clause 11: The method of claim 10, wherein the step of placing said housing into said centering frame includes extending said threaded portions of said plurality of extension rods through said through-holes of said flange portion.

Clause 12: The method of claim 10 or 11, wherein the step of securing said housing to said centering frame includes tightening said plurality of fixtures against said flange portion of said housing to place said tension rods in tension.

Clause 13: The method any one of claims 10 through 12, wherein said instructions include a template for mounting said bracket and said centering frame to a deck of said watercraft.

Clause 14: The method of any one of claims 10 through 13, wherein said instructions include securing said template at a location on said deck and using said template for marking locations of at least one of: boring through-holes for passage of fuel lines; mounting said centering frame to said deck; and mounting said base portion of said bracket to said deck.

Clause 15: The method of any one of claims 10 through 14, wherein said instructions include securing said template at a location on said deck and using said template for at least one of: guiding a drill bit for boring through-holes for passage of fuel lines; tracing at least a partial outline of said centering frame; and tracing at least a partial outline of said base portion of said bracket.

Clause 16: The method of any one of claims 10 through 15, wherein said instructions include connecting a fuel line to said fuel-water separator assembly.

Clause 17: The method of any one of claims 10 through 16, wherein said instructions include mounting a fuel-water separator assembly to said bracket.

Clause 18: The method of any one of claims 10 through 17, wherein said kit includes said fuel-water separator assembly.

What is claimed is:

1. A containment system for a fuel-water separator assembly, comprising:
a bracket including a base portion and an upright portion, the base portion defining a through-hole that receives a fastener for affixing the bracket to a platform of a watercraft, the upright portion extending vertically from the base portion and defining a plurality of mounting apertures configured to receive corresponding mounting fasteners for mounting a fuel-water separator assembly, the plurality of mounting apertures defining a pattern that corresponds to a mounting hole pattern for the fuel-water separator assembly;
a centering frame including at least one frame member for surrounding the base portion of the bracket, the centering frame defining a plurality of mounting apertures that receives corresponding fasteners for affixing the centering frame to the platform of the watercraft, the centering frame defining a plurality of through-apertures that extend through an upper face of the centering frame, the centering frame defining at least one cavity accessible from a lower face of the centering frame, each of the plurality of through-apertures extending into a corresponding of the at least one cavity, each of the at least one cavity defining an inner dimension that is greater than a diameter of the through-apertures of the plurality of through-apertures;
a housing including a closed top portion and an open bottom portion, the open bottom portion defining a radial outer perimeter dimensioned to seat within the centering frame, the housing including one or more radial projections with radial dimensions that are greater than the radial outer perimeter, the one or more radial projections defining a plurality of through-holes, each of the plurality of through-holes for axial alignment with a corresponding one of the plurality of through-apertures of the centering frame;
a plurality of tension rods corresponding to the plurality of through-apertures of the centering frame and to the plurality of through-holes of the one or more radial projections of the housing, each of the plurality of tension rods including a shaft portion and a head portion, the head portion being disposed at a first end of the shaft portion, the shaft portion defining a threaded portion that extends to a second end of the shaft portion, each tension rod being extendible through a respective one of the plurality of through-apertures of the centering frame for capturing the head portion within the at least one cavity of the centering frame and through a respective one of the plurality of through-holes of the one or more radial projections for extending the threaded portion through the at least one radial projection; and
a plurality of fixtures, one for each of the plurality of tension rods, for receiving the threaded portion of one of the plurality of tension rods to secure the one of the plurality of tension rods to the at least one radial projection.

2. The containment system of claim 1, wherein the fastener is one of a wood screw and a lag bolt.

3. The containment system of claim 1, wherein the watercraft is a pontoon boat.

4. The containment system of claim 1, wherein the mounting fastener is a bolt having one of a hex head, a screw driver, and a socket head.

5. The containment system of claim 1, wherein the mounting aperture is threaded for threaded coupling with the mounting fastener.

6. The containment system of claim 1, wherein the centering frame includes an internal lip that extends radially inward, the housing being coupled to the centering frame in axial alignment with the internal lip in a closed configuration.

7. The containment system of claim 1, wherein the at least one cavity is a plurality of cavities, each of the plurality of cavities defining an axial cross-section dimensioned to receive and rotationally capture the head portion of the tension rod.

8. The containment system of claim 1, wherein each of the at least one frame member of the centering frame defines a hollow accessible from the lower face of the centering frame, the hollow defining the at least one cavity.

9. The containment system of claim 1, wherein each of the plurality of fixtures includes a knob for manual manipulation of the fixture onto the threaded portion of the tension rod.

10. A method for containment of a fuel-water separator assembly, comprising:
providing a kit including the containment system of claim 1; and
providing instructions on a tangible, non-transient medium, the instructions including:
placing the housing into the centering frame to cover the bracket and a fuel-water separator assembly mounted to the bracket; and
securing the housing to the centering frame with the plurality of tension rods and the plurality of fixtures.

11. The containment system of claim 1, wherein the step of placing the housing into the centering frame includes extending the threaded portions of the plurality of extension rods through the through-holes of the flange portion.

12. The containment system of claim 1, wherein the step of securing the housing to the centering frame includes tightening the plurality of fixtures against the flange portion of the housing to place the tension rods in tension.

13. The containment system of claim 1, wherein the instructions include a template for mounting the bracket and the centering frame to a deck of the watercraft.

14. The containment system of claim 13, wherein the instructions include:
securing the template at a location on the deck and using the template for marking locations of at least one of:
boring through-holes for passage of fuel lines; and
mounting the centering frame to the deck; and
mounting the base portion of the bracket to the deck.

15. The containment system of claim 13, wherein the instructions include:
securing the template at a location on the deck and using the template for at least one of:
guiding a drill bit for boring through-holes for passage of fuel lines;
tracing at least a partial outline of the centering frame; and
tracing at least a partial outline of the base portion of the bracket.

16. The containment system of claim 1, wherein the instructions include connecting a fuel line to the fuel-water separator assembly.

17. The containment system of claim 1, wherein the instructions include mounting a fuel-water separator assembly to the bracket.

18. The containment system of claim 1, wherein the kit includes the fuel-water separator assembly.
